(19) United States
(12) Patent Application Publication
(10) Pub. No.: US 2008/0171456 A1
(43) Pub. Date: Jul. 17, 2008

(54) Swivel single pole electrical connectors

(76) Inventor: Augusto Vanzo, Bollate (IT)

Correspondence Address: Mr. Michael S. Leonard;Everest Intellectual Property Law Group, 3501 Woodhead Drive, Northbrook, IL, 60062, US

(21) Appl. No.: 11/654,106

(22) Filed: Jan. 17, 2007

(51) Int. Cl. H01R 3/00; H01R 43/027

(52) U.S. Cl. 439/164; 29/882

(57) ABSTRACT

An electrical connector, particularly a single pole electrical connector, has a first connector body portion having an engagement structure capable of engagement with a mating electrical connector. An electrical contact is provided adjacent the first connector body portion. A second connector body portion is connected to the electrical contact and has an electrical cable engagement portion capable of engagement with an electrical cable. The first and second connector body portions are rotatably engaged with each other and rotatable relative to each other about a longitudinal axis of the electrical connector. The first connector body portion rotates about the longitudinal axis independently of the second connector body portion and the electrical contact. Rotation of the electrical cable is not required to connect the single pole electrical connector to the mating electrical connector.

### BACKGROUND OF THE INVENTION

The present invention generally pertains to electrical connectors or electrical interconnecting devices. More specifically, the present invention pertains to single pole electrical connectors having an electrical contact and a connector body for connecting to a mating electrical connector in which the connector body and the electrical contact can rotate relative to each other, i.e. swivel. In embodiments of the present invention, electrical connectors provide for rotation of the connector body during coupling to the mating electrical connector without rotation of an electrical cable electrically connected to the electrical contact. The present invention also pertains to methods related to the electrical connectors, such as methods of making electrical connectors and methods of using electrical connectors.

Single pole electrical connectors exist. Single pole electrical connectors typically have a housing and an electrical contact which are rigidly connected to each other. An electrical cable is rigidly connected to the electrical connector and electrically connected to the electrical contact. Accordingly, the housing cannot rotate relative to the electrical contact and the electrical cable. Rather, the housing, the electrical contact and the electrical cable must rotate or twist together as one unit. When the single pole electrical connector is connected to a mating electrical connector, the housing and the electrical contact are rotated and the electrical cable is twisted to couple with the mating electrical connector. The rotation and twisting action during coupling can require a high rotational force, particularly for large diameter cables, to twist the cable and rotate the electrical connector. The operator who is connecting the two electrical connectors together is required to apply the high rotational force. Also, the rotational forces stress the components of the two electrical connectors. For example, the locking mechanism, which locks the two electrical connectors together, is subject to rotational stress due to the twisted cable. The operator may also need to apply rotational forces to twist the electrical cable to uncouple the two electrical connectors. The rotational forces and stresses can be detrimental to the electrical connector components. Also, the operator is required to apply the rotational forces necessary to twist the cable.

Examples of electrical connectors can be found in U.S. Pat. No. 3,500,291; U.S. Pat. No. 5,685,730; U.S. Pat. No. 6,309,231 and United Kingdom Patent No. 2,397,181.

Accordingly, needs exist to improve electrical connectors, particularly single pole electrical connectors, for the reasons mentioned above and for other reasons.

### SUMMARY OF THE INVENTION

The present invention provides new electrical connectors and methods, including new single pole electrical connectors. Electrical connectors of the present invention can also be referred to as electrical interconnecting devices. In embodiments, the electrical connectors or electrical interconnecting devices can receive electrical power, transmit electrical power, receive electrical signals or transmit electrical signals, for example. The electrical connectors have an electrical contact and a connector body for connecting to a mating electrical connector in which the electrical contact and the connector body can rotate relative to each other. The present invention is described in an embodiment of a single pole electrical connector, particularly a receptacle. However, the present invention is broader than single pole electrical connectors or receptacles and is not limited to single pole electrical connectors and receptacles. The single pole electrical connector provides for rotation or swiveling of the connector body during coupling to and decoupling from the mating electrical connector without axial rotation or twisting of the electrical cable electrically connected to the electrical contact. The single pole electrical connector can be connected to a mating electrical connector without twisting the electrical cable.

The swivel rotation of the electrical connector can reduce or even eliminate stresses that would otherwise occur without the swivel rotation. For example, rotational stress on the electrical cable can be reduced or eliminated. Also, stress on a locking mechanism which locks two mating electrical connectors together can be reduced or eliminated. Furthermore, the swivel rotation of the electrical connector can reduce or prevent inadvertent decoupling of two mating electrical connectors. Safety can also be enhanced by the swivel rotation of the electrical connector.

In an embodiment of the present invention, an electrical connector has a first connector body portion having an engagement structure capable of engagement with a mating electrical connector. An electrical contact is adjacent the first connector body portion. A second connector body portion is connected to the electrical contact. The first and second connector body portions are rotatably engaged with each other and rotatable relative to each other about a longitudinal axis of the electrical connector. The first connector body portion rotates about the longitudinal axis independently of the second connector body portion and the electrical contact.

The second connector body portion may have an electrical cable engagement portion capable of engagement with an electrical cable.

The electrical connector may be a single pole electrical connector.

The first and second connector body portions may have generally cylindrical shapes, and the second connector body portion may have a sleeve positioned in an interior of the first connector body portion. The sleeve may be in rotational sliding contact with an interior surface of the first connector body portion. The electrical connector may also have a rotation-permitting engagement member engaged with at least one of the sleeve and the first connector body portion. The rotation-permitting engagement member may be a split ring. The split ring may be positioned in a channel in the sleeve and in a channel in the first connector body portion.

The electrical connector may also have a fluid seal between the first and second connector body portions.

The electrical connector may provide that the first connector body portion has a generally cylindrical contact surface, the second connector body portion has a generally cylindrical contact surface, and the contact surfaces of the first and second connector body portions are in rotational sliding contact with each other. The contact surface of the first connector body portion may be an interior surface of the first connector body portion, and the contact surface of the second connector body portion may be an exterior surface of the second connector body portion. The electrical connector may also have a rotation-permitting engagement member engaged with at least one of a wall having the contact surface of the first connector body portion and a wall having the contact surface of the second connector body portion. The rotation-permitting engagement member may be a split ring positioned in a channel in the wall of the contact surface of the first connector body portion and in a channel of the wall of the contact surface of the second connector body portion.

One of the first and second connector body portions may also have an intermediate connector body portion, in which the intermediate connector body portion is rotatably engaged with the other one of the first and second connector body portions. The first, second and intermediate connector body portions may have generally cylindrical shapes, and the intermediate connector body portion may have a sleeve positioned in an interior of the first connector body portion, and the second connector body portion may have a sleeve positioned in an interior of the intermediate connector body portion. The electrical connector may also have a rotation-permitting engagement member engaged with at least one of the intermediate connector body portion and the second connector body portion. The rotation-permitting engagement member may be a split ring. The split ring may be positioned in a channel in the intermediate connector body portion and in a channel in the second connector body portion. The electrical connector may also have a fluid seal between the second and intermediate connector body portions. The electrical connector may also have a fluid seal between the first and intermediate connector body portions.

In an embodiment of the present invention, a single pole electrical connector has a first connector body portion having an engagement structure capable of engagement with a mating electrical connector. An electrical contact is adjacent the first connector body portion. A second connector body portion is connected to the electrical contact and has an electrical cable engagement portion capable of engagement with an electrical cable. The first and second connector body portions are rotatably engaged with each other and rotatable relative to each other about a longitudinal axis of the electrical connector. The first connector body portion rotates about the longitudinal axis independently of the second connector body portion and the electrical contact.

The first and second connector body portions may have generally cylindrical shapes, the second connector body portion may have a sleeve positioned in an interior of the first connector body portion, and the sleeve may be in rotational sliding contact with an interior surface of the first connector body portion. The single pole electrical connector may also have a rotation-permitting engagement member engaged with at least one of the sleeve and the first connector body portion. The rotation-permitting engagement member may be a split ring positioned in a channel in the sleeve and in a channel in the first connector body portion.

The single pole electrical connector may also have a fluid seal between the first and second connector body portions.

One of the first and second connector body portions may also have an intermediate connector body portion, in which the intermediate connector body portion is rotatably engaged with the other one of the first and second connector body portions. The first, second and intermediate connector body portions may have generally cylindrical shapes, and the intermediate connector body portion may have a sleeve positioned in an interior of the first connector body portion, and the second connector body portion may have a sleeve positioned in an interior of the intermediate connector body portion. The single pole electrical connector may also have a rotation-permitting engagement member engaged with at least one of the intermediate connector body portion and the second connector body portion. The rotation-permitting engagement member may be a split ring positioned in a channel in the intermediate connector body portion and in a channel in the second connector body portion.

The single pole electrical connector may also have a fluid seal between the second and intermediate connector body portions, and a fluid seal between the first and intermediate connector body portions.

In an embodiment of the present invention, there is provided a method of connecting a single pole electrical connector to a mating electrical connector, in which the single pole electrical connector has a first connector body portion, a second connector body portion and an electrical contact connected to the second connector body portion. The method includes rotating the first connector body portion having an engagement structure capable of engagement with the mating electrical connector without rotating the second connector body portion and the electrical contact.

Embodiments of the present invention may have various features and provide various advantages. Any of the features and advantages of the present invention may be desired, but, are not necessarily required to practice the present invention.

One advantage of the present invention can be to provide new electrical connectors.

Another advantage of the present invention can be to provide new swivel single pole electrical connectors.

Another advantage of the present invention can be to provide single pole electrical connectors that allow relative rotation between a connector body and an electrical contact.

A further advantage of the present invention can be to connect an electrical connector having an electrical cable to a mating electrical connector without twisting the electrical cable.

Yet another advantage of the present invention can be to reduce the amount of force applied by an operator to couple and/or uncouple electrical connectors.

Further advantages of the present invention can be to reduce or eliminate stress applied to electrical connectors during coupling with a mating electrical connector, when coupled to the mating electrical connector, and/or during uncoupling from the mating electrical connector.

Another advantage of the present invention can be to reduce or prevent inadvertent opening of two electrical connectors connected together.

Another advantage of the present invention can be to enhance safety of electrical connectors.

Yet another advantage of the present invention can be to provide improved single pole electrical connectors.

Other advantages may include providing new methods, such as new methods of making electrical connectors, methods of using electrical connectors and methods of coupling electrical connectors together.

Additional features and advantages of the present invention are described in, and will be apparent from, the following Detailed Description of the Invention and the figures. The features and advantages may be desired, but, are not necessarily required to practice the present invention.

### BRIEF DESCRIPTION OF THE FIGURES

FIG. 1 is a perspective view of a swivel single pole electrical connector according to the present invention.

FIG. 2 is a partially exploded perspective view of the swivel single pole electrical connector.

FIG. 3 is a partial cross-sectional view of the swivel single pole electrical connector.

FIG. 4 is an enlarged view of a portion of FIG. 3 and shows an electrical cable connected to an electrical contact.

FIG. 5 is a perspective view of another swivel single pole electrical connector according to the present invention.

FIG. 6 is a partially exploded perspective view of the swivel single pole electrical connector of FIG. 5.

FIG. 7 is a further partially exploded perspective view of the swivel single pole electrical connector of FIG. 5.

FIG. 8 is a partial cross-sectional view of the swivel single pole electrical connector of FIG. 5.

FIG. 9 is an enlarged view of a portion of FIG. 8.

### DETAILED DESCRIPTION OF THE INVENTION

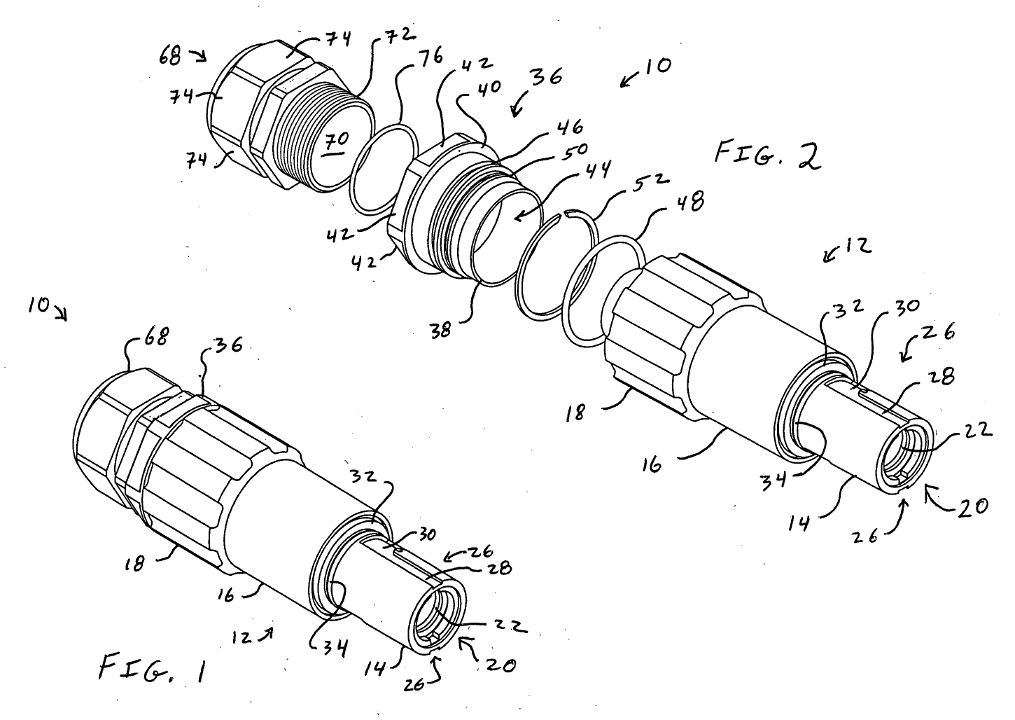

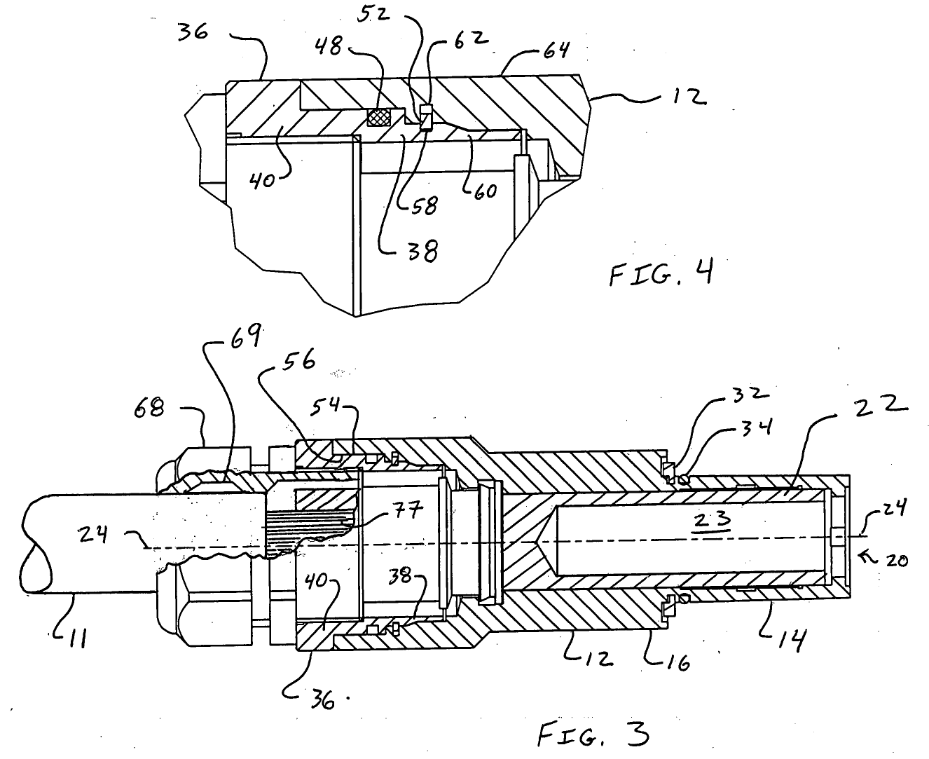

One example of a swivel single pole electrical connector 10 according to the present invention is shown in FIGS. 1-4. The swivel single pole electrical connector 10 is attached to a free end of an electrical cable 11 (FIG. 3) and can be connected to and disconnected from a mating electrical connector (not shown). The embodiment of the present invention shown in Figure is a single pole receptacle electrical connector which can be engaged with a mating single pole plug electrical connector. Existing single pole electrical connectors, including plugs and receptacles, are available from Van-System s.r.l., Milan, Italy and Clements National Company, Chicago, Ill. The present invention is an improvement over existing electrical connectors, particularly single pole electrical connectors. The swivel single pole electrical connector 10 allows for axial rotation of a body portion of the electrical connector that engages with the mating electrical connector without axial rotation of the electrical contact and without axial rotation of another body portion that is connected to the electrical contact. Also, the electrical cable 11 is not twisted during engagement of the swivel single pole electrical connector 10 to the mating electrical connector.

Referring to FIGS. 1-4, the swivel single pole electrical connector 10 has a first connector body portion 12 having a smaller diameter cylinder 14 rigidly extending from a larger diameter cylinder 16 which has an annular hand grip 18. The first connector body portion 12 has a generally cylindrical shape. A bore 20 extends from a free end of the smaller diameter cylinder 14 inward into the first connector body portion 12. An electrical contact 22 is positioned adjacent the first connector body portion 12. More specifically, the electrical contact 22 is a hollow cylindrical electrical contact (female electrical contact) positioned inside of the bore 20 about a longitudinal axis 24 (FIG. 3) of the swivel single pole electrical connector 10. The electrical contact 22 has a bore 23 which is accessible from the open end of the smaller diameter cylinder 14.

The smaller diameter cylinder 14 has an engagement structure 26 capable of engagement with a mating electrical connector (not shown), such as a single pole electrical plug. The engagement structure 26 is a so-called bayonet lock having L-shaped channels at two exterior locations on the smaller diameter cylinder 14. Projections or pins on the mating single pole electrical plug slide into axially extending legs 28 of the L-shaped channels 26 and the male electrical contact of the mating plug is inserted into the female electrical contact 22 of the swivel single pole electrical connector 10. The first connector body portion 12 is rotated about the longitudinal axis 24 and the pins of the plug slide into the radially extending legs 30 of L-shaped channels 26. One or more seals can be provided to fluidly seal the connection between the swivel single pole electrical connector 10 and the mating electrical connector. The swivel single pole electrical connector 10 has a ring seal 32 at the junction of the smaller and larger diameter cylinders 14, 16 and also an o-ring seal 34. Operation of the swivel single pole electrical connector 10 will be further described below.

The swivel single pole electrical connector 10 has a second connector body portion 36. The second connector body portion 36 has a cylindrical sleeve 38 rigidly extending from an enlarged diameter flange 40. The flange 40 has external flat faces 42 for gripping, for example, by a tool. The second connector body portion 36 has a generally cylindrical shape with an axial bore 44 extending through the second connector body portion 36. The cylindrical sleeve 38 has a radially extending channel 46 for an o-ring seal 48 on an exterior surface. The cylindrical sleeve 38 also has a radially extending channel 50 for a split ring 52.

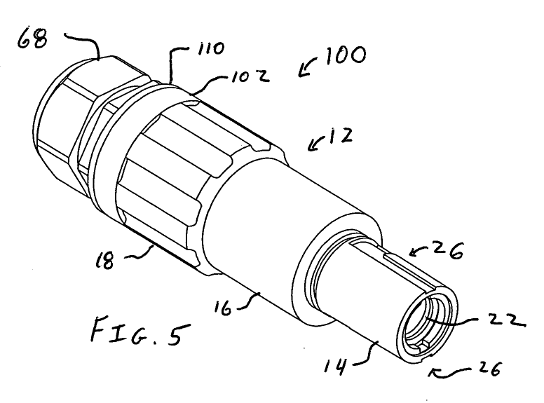

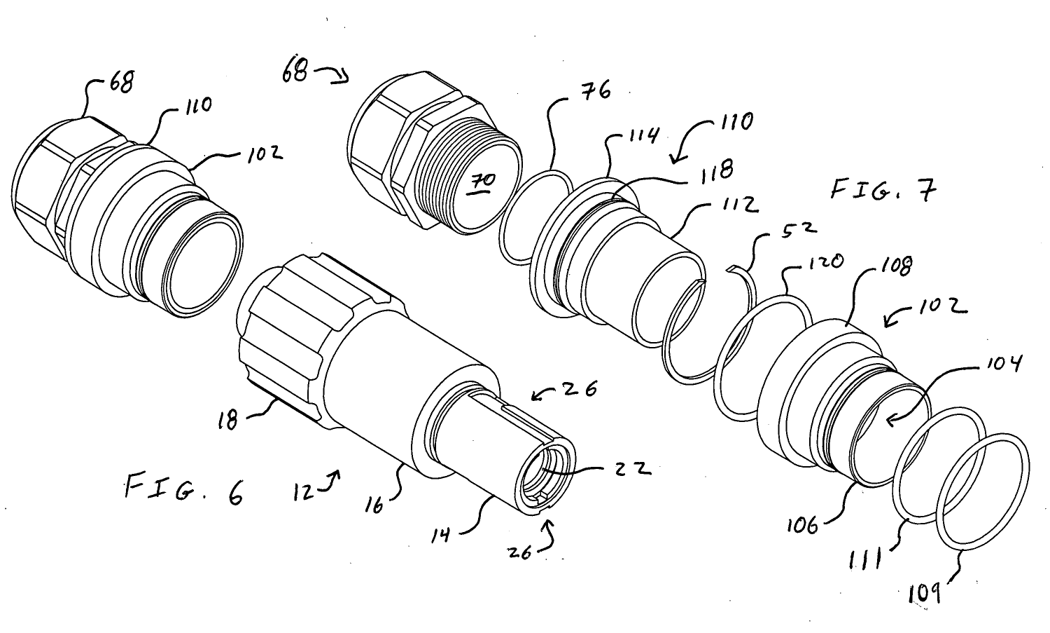

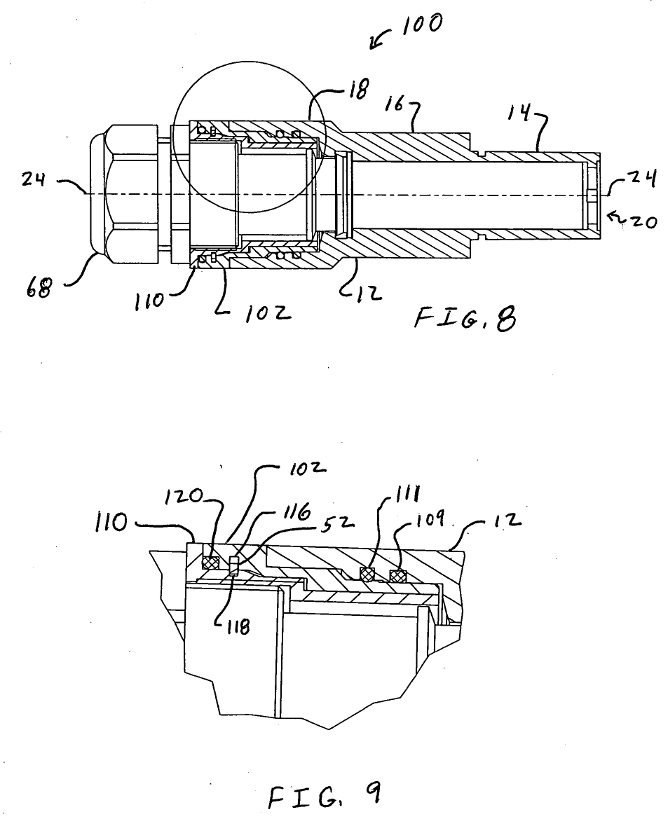

Referring mainly to FIGS. 3 and 4, the cylindrical sleeve 38 of the second connector body portion 36 is positioned in an interior of the first connector body portion 12. The first connector body portion 12 has a generally cylindrical interior contact surface 54. The cylindrical sleeve 38 of the second connector body portion 36 has a generally cylindrical exterior contact surface 56. The contact surfaces 54, 56 of the first and second connector body portions 12, 36 are in rotational sliding contact with each other. In other words, the first and second connector body portions 12, 36 can be rotated about the longitudinal axis 24 relative to each other, and independent of each other.

The first and second connector body portions 12, 36 are rotatably engaged with each other by the split ring 52. The split ring 52 is positioned in a channel 58 in a wall 60 of the cylindrical sleeve 38 of the second connector body portion 36 and in a channel 62 in a wall 64 of the first connector body portion 12. The split ring 52 allows the first and second connector body portions 12, 36 to rotate about the longitudinal axis 24 relative to each other while being engaged together. The split ring 52 is one example of a rotation-permitting engagement member that engages the cylindrical sleeve 38 and the first connector body portion 12 together. The present invention can be practiced with other structures that function as a rotation-permitting engagement member. For example, the rotation-permitting engagement member could be a projection extending from one of the first and second connector body portions and engaged with the other one of the first and second connector body portions.

The swivel single pole electrical connector 10 also has the o-ring 48 as a fluid seal between the first and second connector body portions 12, 36. More specifically, the o-ring seal 48 is positioned in a channel 66 in the wall 60 of the cylindrical sleeve 38 of the second connector body portion 36. The o-ring seal 48 is in contact with the first and second connector body portions 12, 36 and forms a fluid tight seal.

Referring to FIGS. 1-4, the swivel single pole electrical connector 10 has an electrical cable attachment portion 68 for attachment to the electrical cable 11. The electrical cable attachment portion 68 can be connected to the electrical cable 11 by any suitable mechanism, for example, by a compression sleeve or strain relief grommet 69. The strain relief grommet 69 is rigidly connected to the cable 11 and can provide a seal to prevent entry of fluids. The electrical cable attachment portion 68 has a generally cylindrical shape with an axial bore 70 extending through the electrical cable attachment portion 68. The electrical cable attachment portion 68 has a threaded sleeve 72 for threading engagement with the second connector body portion 36. The electrical cable attachment portion 68 has external flat faces 74 for gripping, for example, by a tool. The electrical cable 11 extends through the bore 70 and is terminated at the electrical connector 22, i.e. electrically connected to the electrical connector 22. The electrical cable 11 can be connected to the electrical connector 22 by any suitable mechanism, for example, by crimping at a contact crimp barrel 71 of the electrical connector 22, set screw or threaded post. The electrical cable attachment portion 68 can be considered as part of the second connector body portion 36. A seal, such as an o-ring 76, is provided on the exterior of the threaded sleeve 72 to provide a fluid seal between the electrical cable attachment portion 68 and the second connector body portion 36. The electrical cable 11 can be any suitable electrical cable, for example, a cable having multiple strands of wire 77.

Operation of the swivel single pole electrical connector 10 will now be further described. The swivel single pole electrical connector 10 is attached to a mating electrical connector by positioning the swivel single pole electrical connector 10 in alignment with the mating electrical connector. The electrical contact 22 should be in alignment with the mating electrical contact and the engagement structure 26 (L-shaped channels) should be in alignment with the corresponding engagement structure (pins) on the mating electrical connector. The swivel single pole electrical connector 10 is slid onto the mating electrical connector until the pins on the mating electrical connector travel along the axially extending legs 28 of the L-shaped channels 26 and reach the radially extending legs 30 of the L-shaped channels 26. The second connector body portion 36 and the electrical cable attachment portion 68 are now held in position without rotation about the longitudinal axis 24. The first connector body portion 12 is rotated about the longitudinal axis 24 such that the pins of the mating electrical connector move into the radially extending legs 30 of the L-shaped channels 26. The contact surface 54 of the first connector body portion 12 rotatably slides relative to the contact surface 56 of the cylindrical sleeve 38 of the second connector body portion 36. The split ring 52 maintains engagement of the first and second connector body portions 12, 36 while allowing the first connector body portion 12 to rotate relative to the second connector body portion 36.

Because the first and second connector body portions 12, 36 are rotatably engaged with each other and rotatable relative to each other about the longitudinal axis 24 of the electrical connector 10, the second connector body portion 36 does not rotate when the first connector body portion 12 rotates. Also, the electrical contact 22 does not rotate when the first connector body portion rotates 12. In other words, the first connector body portion 12 rotates about the longitudinal axis 24 independently of the second connector body portion 36 and the electrical contact 22. Also, the electrical cable 11 connected to the electrical contact 22 does not rotate or twist when the first connector body portion 12 rotates. The swivel single pole electrical connector 10 is disconnected from the mating electrical connector by reversing the connection procedure.

Another example of a swivel single pole electrical connector 100 according to the present invention is shown in FIGS. 5-9. The swivel single pole electrical connector 100 is similar to the swivel single pole electrical connector 10 of FIGS. 1-4, and the same reference numbers are used for like components. The single pole electrical connector 100 has an intermediate connector body portion 102 which has a generally cylindrical shape with a bore 104 through the intermediate connector body portion 102. The intermediate connector body portion 102 has a sleeve 106 extending from a flange 108, and the sleeve 106 is positioned in an interior of the first connector body portion 12. An O-ring seal 109 provides a fluid tight seal between the first and intermediate connector body portions 12, 102. An O-ring 11 retains the first and intermediate connector body portions 12, 102 together.

The second connector body portion 110 of the swivel single pole connector 100 has a sleeve 112 extending from a flange 114, and the sleeve 112 is positioned in an interior of the intermediate connector body portion 102.

A split ring 52 is positioned in a channel 116 in the intermediate connector body portion 102 and in a channel 118 in the second connector body portion 110. The split ring 52 maintains engagement of the second connector body portion 110 with the intermediate connector body portion 102 while allowing relative rotation between the second and intermediate connector body portions 110, 102. The split ring 52 can be referred to as a rotation-permitting engagement member, and other rotation-permitting engagement members or structures could be used which retain engagement of the second and intermediate connector body portions 110, 102 while allowing relative rotation. For example, the rotation-permitting engagement member could be a projection extending from one of the intermediate and second connector body portions 102, 110 and engaged with the other one of the intermediate and second connector body portions 102, 110.

An o-ring 120 is provided between the second and intermediate connector body portions 110, 102. The o-ring 120 provides a fluid seal between the second and intermediate connector body portions 110, 102.

FIGS. 5-9 show the second and intermediate connector body portions 110, 102 as being rotatably engaged for relative rotation. Accordingly, the intermediate connector body portion 102 can be considered as part of the first connector body portion 12.

In another alternative embodiment, the intermediate connector body portion 102 is rotatably engaged with the first connector body portion 12 for relative rotation, for example by a split ring 52. In this alternative embodiment, the intermediate connector body portion 102 can be considered to be part of the second connector body portion 110.

In yet another alternative embodiment, the intermediate connector body portion 102 can be rotatably engaged with the second connector body portion 110 for relative rotation, for example by a split ring 52, and also rotatably engaged with the first connector body portion 12 for relative rotation, for example by a split ring 52.

The swivel rotation of the present invention can be embodied in either one or both mating electrical connectors, for example, in either one or both of a plug and a socket.

The present invention is described in terms of a single pole electrical connector, particularly a socket. However, the present invention can be practiced in numerous different embodiments. For example, the present invention can be practiced in embodiments other than single pole electrical connectors, such as electrical connectors having multiple electrical contacts. The present invention can be practiced in embodiments other than sockets, for example, plugs. Yet another exemplary embodiment of the present invention is an electrical connector mounted to a panel.

Embodiments of the present invention can be used for many different applications. For example, the present invention can be used in power cable applications and control cable applications. The present invention can be embodied in electrical connectors used in, for example, lighting applications, marine applications, oil applications, natural gas applications, train applications, and crane applications. These are merely examples of applications of the present invention and the present invention is not limited to these examples.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1. An electrical connector, comprising:
a first connector body portion having an engagement structure capable of engagement with a mating electrical connector;
an electrical contact adjacent the first connector body portion; and
a second connector body portion connected to the electrical contact, the first and second connector body portions rotatably engaged with each other and rotatable relative to each other about a longitudinal axis of the electrical connector;
wherein the first connector body portion rotates about the longitudinal axis independently of the second connector body portion and the electrical contact.

2. The electrical connector of claim 1, wherein the second connector body portion has an electrical cable engagement portion capable of engagement with an electrical cable.

3. The electrical connector of claim 1, wherein the electrical connector is a single pole electrical connector.

4. The electrical connector of claim 1, wherein the first and second connector body portions have generally cylindrical shapes, and wherein the second connector body portion has a sleeve positioned in an interior of the first connector body portion.

5. The electrical connector of claim 4, wherein the sleeve is in rotational sliding contact with an interior surface of the first connector body portion.

6. The electrical connector of claim 4, further comprising a rotation-permitting engagement member engaged with at least one of the sleeve and the first connector body portion.

7. The electrical connector of claim 6, wherein the rotation-permitting engagement member is a split ring.

8. The electrical connector of claim 7, wherein the split ring is positioned in a channel in the sleeve and in a channel in the first connector body portion.

9. The electrical connector of claim 1, further comprising a fluid seal between the first and second connector body portions.

10. The electrical connector of claim 1, wherein
the first connector body portion has a generally cylindrical contact surface;
the second connector body portion has a generally cylindrical contact surface; and
the contact surfaces of the first and second connector body portions are in rotational sliding contact with each other.

11. The electrical connector of claim 10, wherein the contact surface of the first connector body portion is an interior surface of the first connector body portion, and the contact surface of the second connector body portion is an exterior surface of the second connector body portion.

12. The electrical connector of claim 10, further comprising a rotation-permitting engagement member engaged with at least one of a wall having the contact surface of the first connector body portion and a wall having the contact surface of the second connector body portion.

13. The electrical connector of claim 12, wherein the rotation-permitting engagement member is a split ring positioned in a channel in the wall of the contact surface of the first connector body portion and in a channel of the wall of the contact surface of the second connector body portion.

14. The electrical connector of claim 1, wherein one of the first and second connector body portions further comprises an intermediate connector body portion, the intermediate connector body portion is rotatably engaged with the other one of the first and second connector body portions.

15. The electrical connector of claim 14, wherein the first, second and intermediate connector body portions have generally cylindrical shapes, and wherein the intermediate connector body portion has a sleeve positioned in an interior of the first connector body portion, and the second connector body portion has a sleeve positioned in an interior of the intermediate connector body portion.

16. The electrical connector of claim 15, further comprising a rotation-permitting engagement member engaged with at least one of the intermediate connector body portion and the second connector body portion.

17. The electrical connector of claim 16, wherein the rotation-permitting engagement member is a split ring.

18. The electrical connector of claim 17, wherein the split ring is positioned in a channel in the intermediate connector body portion and in a channel in the second connector body portion.

19. The electrical connector of claim 14, further comprising a fluid seal between the second and intermediate connector body portions.

20. The electrical connector of claim 19, further comprising a fluid seal between the first and intermediate connector body portions.

21. A single pole electrical connector, comprising:
a first connector body portion having an engagement structure capable of engagement with a mating electrical connector;
an electrical contact adjacent the first connector body portion; and
a second connector body portion connected to the electrical contact and having an electrical cable engagement portion capable of engagement with an electrical cable, the first and second connector body portions rotatably engaged with each other and rotatable relative to each other about a longitudinal axis of the electrical connector;
wherein the first connector body portion rotates about the longitudinal axis independently of the second connector body portion and the electrical contact.

22. The single pole electrical connector of claim 21, wherein
the first and second connector body portions have generally cylindrical shapes;
the second connector body portion has a sleeve positioned in an interior of the first connector body portion; and
the sleeve is in rotational sliding contact with an interior surface of the first connector body portion.

23. The single pole electrical connector of claim 22, further comprising a rotation-permitting engagement member engaged with at least one of the sleeve and the first connector body portion.

24. The single pole electrical connector of claim 23, wherein the rotation-permitting engagement member is a split ring positioned in a channel in the sleeve and in a channel in the first connector body portion.

25. The single pole electrical connector of claim 21, further comprising a fluid seal between the first and second connector body portions.

26. The single pole electrical connector of claim 21, wherein one of the first and second connector body portions further comprises an intermediate connector body portion, the intermediate connector body portion is rotatably engaged with the other one of the first and second connector body portions.

27. The single pole electrical connector of claim 26, wherein the first, second and intermediate connector body portions have generally cylindrical shapes, and wherein the intermediate connector body portion has a sleeve positioned in an interior of the first connector body portion, and the second connector body portion has a sleeve positioned in an interior of the intermediate connector body portion.

28. The single pole electrical connector of claim 27, further comprising a rotation-permitting engagement member engaged with at least one of the intermediate connector body portion and the second connector body portion.

29. The single pole electrical connector of claim 28, wherein the rotation-permitting engagement member is a split ring positioned in a channel in the intermediate connector body portion and in a channel in the second connector body portion.

30. The single pole electrical connector of claim 21, further comprising a fluid seal between the second and intermediate connector body portions, and a fluid seal between the first and intermediate connector body portions.

31. A method of connecting a single pole electrical connector to a mating electrical connector, in which the single pole electrical connector has a first connector body portion, a second connector body portion and an electrical contact connected to the second connector body portion, comprising:
rotating the first connector body portion having an engagement structure capable of engagement with the mating electrical connector without rotating the second connector body portion and the electrical contact.
